(19) United States
(12) Patent Application Publication
(10) Pub. No.: US 2012/0284745 A1
(43) Pub. Date: Nov. 8, 2012

(54) APPARATUS, SYSTEMS AND METHODS FOR IMPROVING COMMERCIAL PRESENTATION

(75) Inventor: Stephen Strong, Dunwoody, GA (US)

(73) Assignee: ECHOSTAR TECHNOLOGIES L.L.C., Englewood, CO (US)

(21) Appl. No.: 13/102,826

(22) Filed: May 6, 2011

(51) Int. Cl. H04N 7/025

(52) U.S. Cl. 725/34

(57) ABSTRACT

Systems and methods of providing different commercial viewing options for a media content event are disclosed. An example media device receives a user selection identifying one of a plurality of commercial viewing options associated with a media content event; determines if commercials are to be presented within at least one commercial break of the media content event based on the received user selection; selects commercials for presentation based on the received user selected commercial viewing option if commercials are determined to be presented during the at least one commercial break; presents the media content event; and presents selected commercials during designated commercial breaks during presentation of the media content event if commercials are determined to be presented during the at least one commercial break.

### BACKGROUND

When a viewer desires to view a movie in a pay-per-view situation, the viewer must pay a set rate in order to watch the movie. Some viewers may desire to watch dozens of pay-per-view movies in a month. This can undesirably increase the amount they spend monthly for watching these pay-per-view events. Because of these high costs, many viewers decide not to purchase. This creates a loss in potential revenue for the movie distributors.

Accordingly, there is a need in the art to provide a more cost-friendly experience for viewers of pay-per-view events.

### SUMMARY

Exemplary embodiments provide systems and methods for providing different commercial viewing options for a media content event (e.g., movie). Before a media content event is played on a media device, the user is given the option of selecting various commercial viewing options, for example, no commercials for a first price, limited commercials for a second price, and many commercials for free. An example media device receives a user selection identifying one of a plurality of commercial viewing options associated with a media content event; determines if commercials are to be presented within at least one commercial break of the media content event based on the received user selection; selects commercials for presentation based on the received user selected commercial viewing option if commercials are determined to be presented during the at least one commercial break; presents the media content event; and presents selected commercials during designated commercial breaks during presentation of the media content event if commercials are determined to be presented during the at least one commercial break.

### BRIEF DESCRIPTION OF THE DRAWINGS

Preferred and alternative embodiments are described in detail below, with reference to the following drawings:

FIG. 1 is a block diagram of an embodiment of a system;

FIG. 2 is a block diagram of an embodiment of an exemplary media device;

FIG. 3 is a flowchart of an exemplary process performed at a media device;

FIG. 4 is a screen shot of a user interface provided at the media device; and

FIG. 5 is a flowchart of an exemplary process performed by the system shown in FIG. 1.

### DETAILED DESCRIPTION

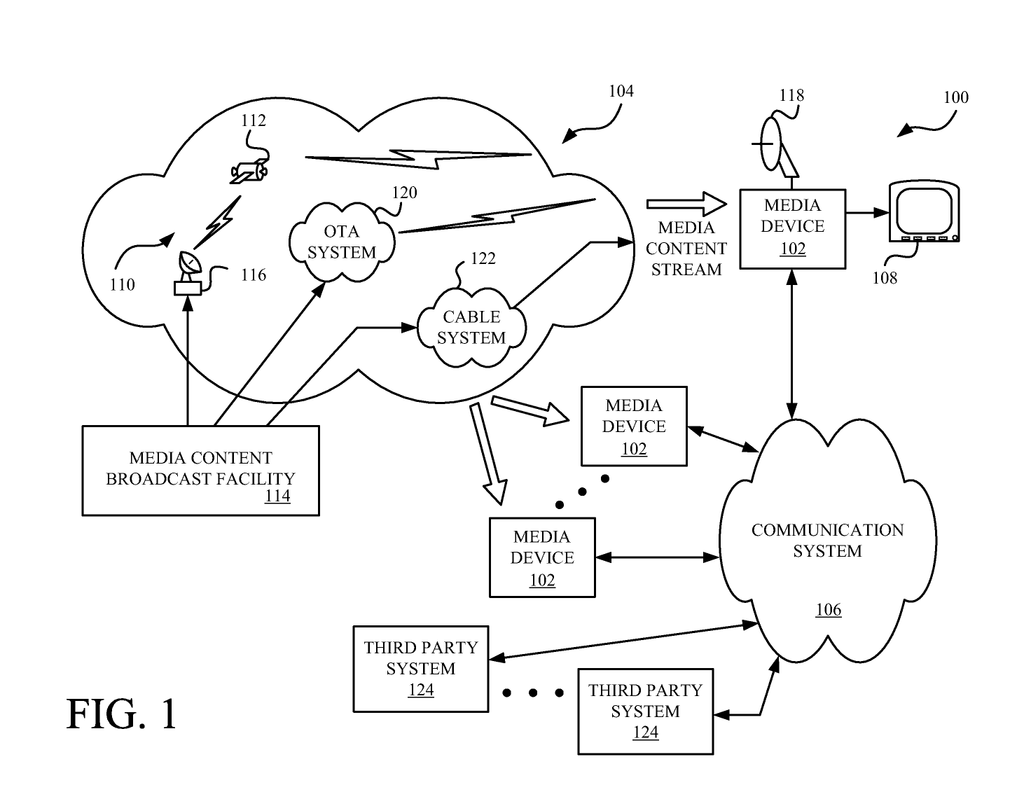

FIG. 1 is a block diagram of an embodiment of a media content pricing system 100. The exemplary embodiment of the media content pricing system 100 is implemented in an exemplary environment that includes a plurality of media devices 102, a broadcast system 104, and a communication system 106.

Before a media content event is played on a media device 102, the user is given the option of selecting various commercial viewing options. For example, no commercials for a first price, limited commercials for a second price, and many commercials for free may be selectable commercial viewing options. The media content event is then presented with commercial breaks (or no commercial breaks) based on the user selection of the commercial viewing options.

In some embodiments, the user commercial viewing-options selection is sent to a server device. The server device may additionally compile demographic information for commercial break time slots for a media content event based on the user's commercial viewing-options selections. Accordingly, a merchant-participant entity, such as an advertising entity or the like, may then bid on commercial time slots for a media content event and/or based on demographic groupings. Commercials selected by the winning bidders are sent to the media devices. Alternatively, or additionally, information of the winning bidders is sent to the media device 102 for selection of commercials associated with, or selected by, the winning merchant-participant entity.

The media devices 102, when in operation, are configured by their respective user to select one of the plurality of simultaneously broadcast media content events for presentation on a media presentation system 108. An exemplary media device 102 includes, but is not limited to, a set-top box (STB) that is communicatively coupled to the broadcast system 104. Other embodiments of the media device 102 include a television (TV), a digital video disc (DVD) player, a game-playing device, a personal computer (PC), an electronic tablet, a cellular phone, a portable media device, or a personal digital assistant (PDA). The media devices 102 present and/or store selected media content events that are included in the media content stream. Exemplary media presentation systems 108 include, but are not limited to, TVs, stereos, radios, surround-sound systems, personal computers, or the like that may be communicatively coupled to the media device 102. In some embodiments, the media device 102 and the media presentation system 108 may be a single integrated electronic media device.

The media devices 102 may be identical to, or may be substantially similar to, other media devices 102. Or, the media devices 102 may be quite different from each other. Further, the media devices 102 may be coupled to different types of broadcast systems 104.

The plurality of media content events are received over a broadcast system 104. An exemplary broadcast system 104 includes a satellite broadcast system 110. One or more of the media content streams resides in a transport channel that is uplinked to a plurality of satellites 112 from a media content broadcast facility 114, via a corresponding transmit antenna 116. The respective transport channels are then wirelessly communicated, from one or more of the satellites 112 to a receiver antenna 118 that is communicatively coupled to the media device 102. The received wireless signal (with the media content stream) is then communicated from the receiver antenna 118 to the media device 102. In one embodiment, the receiver antenna 118 and the media device 102 receive multiple wireless signals from a plurality of satellites 112.

Alternatively, or additionally, the plurality of media content events are broadcast to the media devices 102 via an over-the-air (OTA) system 120. For example, the media content broadcast facility 114 may be a local program provider that wirelessly broadcasts media content events to the media devices 102. The wireless signal with the media content stream is received at the receiver antenna 118, or is received directly by a receiver (not shown) residing in the media device 102.

Alternatively, or additionally, the plurality of media content events are broadcast to the media devices 102 via a cable system 122. For example, the media content broadcast facility 114 may employ a coaxial cable, fiber optic cable, or comparable cable that is coupled to the media device 102 for transmitting the media content stream.

Alternatively, or additionally, the media device 102 may receive the media content event directly from the media content broadcast facility 114 or from another source over the communication system 106, via a communication (network) link. In an exemplary embodiment, the communication system 106 includes a public (the Internet) or private data network. The communication link between the media device 102 and the communication system 106 may be a dedicated communication link, such as an Ethernet communication link, a fiber optic communication link, a wireless link, a cable link, or the like. In some embodiments, the communication links may be established through the communication system 106, or may be established through a portion of the communication system 106.

The media devices and/or the media content broadcast facility 114 may also be in communication with one or more third-party systems, such as the exemplary remote programming content system 124. The media content broadcast facility 114 and/or the remote programming content system 124 may transmit information, such as, but not limited to, electronic program guide (EPG) information or other program purchase plan-related information, to the media devices 102 via the communication system 106 or the broadcast system 104.

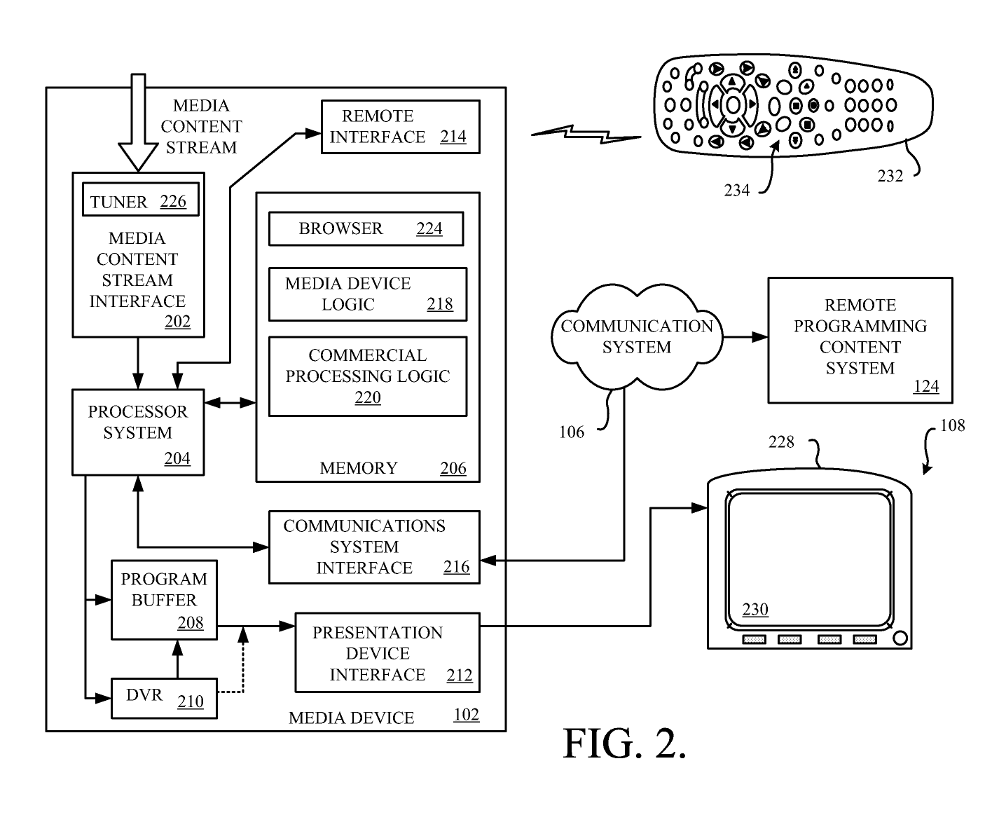

FIG. 2 is a block diagram of an embodiment of an exemplary media device 102. The nonlimiting exemplary media device 102 includes a media content stream interface 202, a processor system 204, a memory 206, a program buffer 208, an optional digital video recorder (DVR) 210, a presentation device interface 212, a remote interface 214, and an optional communication system interface 216. The memory 206 stores media device logic 218, commercial processing logic 220, and a browser 224. In one embodiment, some or all of these memory and other data manipulation functions may be provided by using a remote server or other electronic devices suitably connected, via the communication system 106 or otherwise, to the media device 102. Other media devices may include some, or may omit some, of the above-described media-processing components. Further, additional components not described herein may be included in alternative embodiments.

In an exemplary embodiment, the media content stream is received by the media content stream interface 202. One or more tuners 226 in the media content stream interface 202 selectively tune to a particular media content stream in accordance with instructions received from the processor system 204. The processor system 204, executing the media device logic 218 and based upon a request for a program of interest specified by a user, parses out program content associated with the specified media content event. The media content event of interest is then assembled into a stream of video and/or audio information, which may be stored by the program buffer 208, such that the program content can be streamed out to the media presentation system 108, via the presentation device interface 212. Alternatively, or additionally, the parsed-out program content may be saved into the DVR 210 for later presentation. The DVR 210 may be directly provided in, locally connected to, or remotely connected to the media device 102.

The media content event stream may include portions associated with, or reserved for, commercial breaks. Based on the user selected one of the commercial viewing options, commercials may be selected and added into time slots of the commercial breaks. If the users selects a no commercial option, the commercial breaks will be empty, and thus, not be presented to the user in an exemplary embodiment. In some embodiments, the duration of the commercial breaks are variable. Based on the commercial viewing option selected by the user, and appropriate number of and/or duration of commercials may be selected and added into the portions of the media content event stream associated with the commercial breaks.

In the exemplary embodiment of FIG. 2, the presentation device interface 212 is illustrated as coupled to the media presentation system 108 that includes a visual display device 228, such as a television (hereafter, generically, a TV). Other types of presentation devices may also be coupled to the media device 102, including those providing any sort of stimuli, such as temperature, vibration, and the like sensible by a human being. The video portion of the streamed program content is displayed on the TV display 230 and the audio portion of the streamed program content is reproduced as sounds by the plurality of speakers.

The exemplary media device 102 is configured to receive commands from a user via a remote control 232. The remote control 232 includes one or more controllers 234. The user, by actuating one or more of the controllers 234, causes the remote control 232 to generate and transmit commands, via a wireless signal, to the media device 102. The commands control the media device 102 and/or control the media presentation system 108. The wireless signal may be an infrared (IR) signal or a radio frequency (RF) signal.

The above processes performed by the media device 102 are generally implemented by the processor system 204 while executing the media device logic 218 and/or the commercial processing logic 220. Thus, the media device 102 may perform a variety of functions relating to the processing and presentation of the media content event.

The optional communications system interface 216 is configured to provide connectivity of the media device 102 to other remote devices (server devices, e.g., the third-party system 124) via the communication system 106. In an exemplary embodiment that is configured with Internet connectivity, the communications system interface 216 may be a suitable modem, or a device configured to connect to a modem. For example, the exemplary browser 224 may be used to access and/or retrieve the data from a remote site, such as a Web site. The accessed data may be searched, filtered, sorted, or otherwise processed at the media device 102. Additionally, or alternatively, the retrieved data may be stored by the media device 102, such as in the DVR 210, memory 206, or another suitable memory medium. Commercials received from the third party system 124 or the media content broadcast facility 114 are stored in the memory 206. The communications system interface 216 may be any suitable device that is configured to provide connectivity of the media device 102 to the communication system 106.

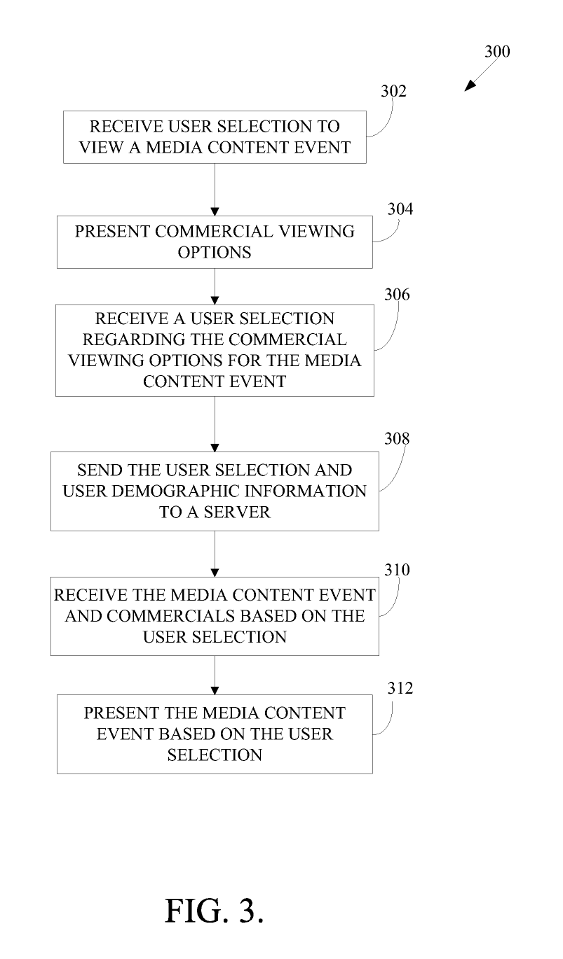

FIG. 3 illustrates an exemplary process 300 performed by the media device 102. First at a block 302, the user selection to view a media content event is received at the processor system 204 via a suitable user interface device (e.g., the remote control 232).

At a block 304, commercial viewing options are presented in a user interface. In an exemplary embodiment, the commercial viewing options include multiple options, each assigned a different pricing value that is to be paid by the user. A commercial viewing option describes a commercial presentation choice that the user may make, where the duration and/or the number of presented commercials vary based on a specified price that the user is required to pay for access to the media content event.

The most expensive commercial viewing option is one that will present the media content event commercial free. That is, no commercials will be presented during presentation of the media content event.

The next commercial viewing option, and presumably a less expensive option, will present the media content event with limited number of commercial breaks and/or with limited duration of the commercial breaks. That is, the user will have to view a few commercials during presentation of the media content event, though the number of presented commercials may be relatively small and/or the duration of presented commercials may be relatively short.

A third exemplary commercial viewing option is free of cost to the user and will present the media content event with a full complement of commercial breaks. That is, the number of presented commercials may be relatively large and/or the duration of presented commercials may be relatively longer.

Accordingly, the user is able to choose a price that they are willing to pay to have access to the media content event, where the price is based on the number and/or duration of presented commercials. Any number of different selectable commercial viewing options may be presented to the user.

Then, at a block 306, the processor system 204 receives a user's selection regarding the commercial viewing options for the media content event, based on the user selection made via the presented commercial viewing option user interface. At a block 308, in some embodiments, the user's selection and demographic information (if available) are sent to a server device (e.g., the third-party operated remote programming content system 124) via the communications system 106. Based on the user's selected commercial viewing option, the number of and/or duration of commercial breaks are defined. Commercials may then be selected and put into time slots based on the defined number of and/or duration of the commercial breaks. In some embodiments, this process may be performed entirely at the media device 102.

At a block 310, the media content event and commercials based on the user's selection and, optionally, the user's demographic information are received, at the media device 102. If demographics are used, particular commercials intended for viewing by that user may be selected.

In an exemplary embodiment, the media content event and commercials may be sent by the media content broadcast facility 114. Alternatively, or additionally, the media content event may be sent by the media content broadcast facility 114 via the broadcast system 104 and some of, or all of, the commercials may be sent by the third-party system 124 via the communications system 106. The media content event and commercials may be sent in other manners from other sources in alternative embodiments. Next at a block 312, the media content event, with or without commercials, is presented according to the commercial processing logic 220 and the user's selection of the commercial viewing option.

Additionally, or alternatively, the media content event and/or commercials may be sent to the media device 102 prior to the user request, and stored in the memory 206. The stored media content event and/or commercials are released for viewing after an authority (e.g., the media content broadcast facility 114) has received and validated a request (which may include payment instructions) from the media device 102. After the validation has been transmitted to the media device 102, along with information pertaining to the selected commercial viewing option, the media content event and the commercials (if any) may be assembled and then presented by the media device 102.

In some embodiments, commercials selected from the memory 206 for viewing are based on demographic information associated with the user who is associated with the media device 102. Demographic information can include various information about the user, such as age, income level, gender, etc. Thus, if the user is a male between 21 and 30 with a moderate income level, then the commercials selected are those targeting this demographic group (e.g., sporting goods and/or beer ads for products typically consumed by users of this demographic).

Additionally, or alternatively, the demographic information may be received from a storage location accessible by the media content broadcast facility 114. The demographic information may be collected by any entity or plurality of entities, and then aggregated for the purposes of selecting commercials targeted to that particular user. For example, but not limited to, demographic information may be previously stored when the user opens and/or activates an account that is managed by a entity operating the media content broadcast facility 114. As another example, prior purchases by the user may be incorporated into the demographic information.

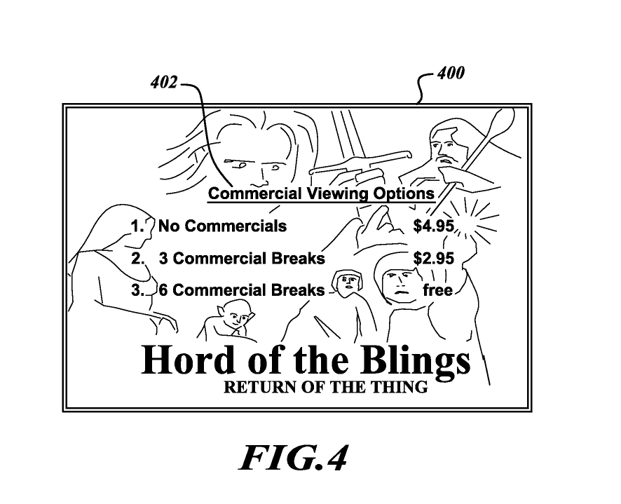

FIG. 4 is a screen shot 400 of a media content event that is unavailable for a user to view until the user has made a selection of one of a plurality of commercial viewing options from a presented user interface 402. In this example, the commercial viewing option user interface 402 provides three commercial viewing options. The most expensive option is one that will present the media content event commercial free. The next option will present the media content event with limited commercial breaks. The last option is free and will present the media content event with a full complement of commercials. Once the user has made their selection of a preferred commercial viewing option, the media content event and the commercials (if any) are presented.

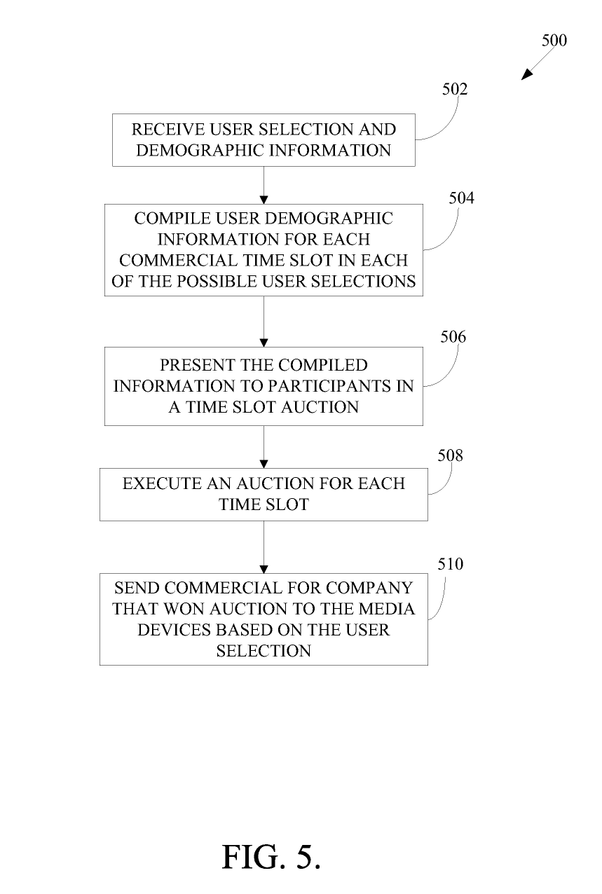

FIG. 5 illustrates an exemplary process 500 performed by a server device (e.g., the media content broadcast facility 114). First at a block 502, user selection and demographic information (optionally) is received at the server device. The user selection is received from the media device 102. If available, the demographic information may be received from the media device 102 or from a storage location associated with and/or accessible by the server device. At a block 504, user demographic information for each commercial time slot in each of the possible user selections may be optionally compiled.

Each commercial break for the media content event includes one or more commercial time slots. The commercial time slots vary in their organization. In one exemplary embodiment, the commercial break is divided into national, regional and local advertisement commercial time slots. The commercial break is defined by a duration (length of time). Each commercial break is divided up into time slots, each with their own time slot durations. Then, particular commercials may be selected based on commercial break durations, time slot durations, quantity of commercials and/or cost.

Length (i.e., duration) and number of the commercial time slots may vary depending upon the selected commercial viewing option. For example, commercial time slots included in a commercial break for a commercial viewing option requiring some reduced amount of payment are shorter in length than commercial time slots included in a commercial break for a another commercial viewing option that requires a greater amount of payment. In the various embodiments, the number of commercial breaks may vary depending upon the selected commercial viewing option.

At a block 506, in an auction-type embodiment, the compiled user demographic information for each commercial time slot is presented to merchant-participants in an auction for the commercial time slots. A merchant-participant is an entity that is interested in purchasing time for their particular commercials for presentation to the various users. The merchant-participants effectively value the commercial time slots through the auction process.

At a block 508, an auction for each time slot is executed. An example auction may present a graph by event (commercial break option) that is broken down in the various demographics (e.g., age, product preference, type of event). This graph may include multiple layers and allow the participating merchant-participant to search for demographic information pertaining to a target user or even groups of users.

In an exemplary embodiment, at a block 510, commercial(s) for the auction merchant-participant(s) that won the auction are sent to the media devices 102. Information of the time slots for the winning commercial(s) is included with the sent commercial(s). The media devices 102 will present the commercial(s) associated with the winning bidders within the time slots according to the time slot information.

Additionally, or alternatively, there may be more than one winner for a time slot if time slots are further segregated according to certain demographic information. For example, a free viewing option may segregated into a group of domestic lager drinkers and another group of dark beer drinkers. In this situation, the first winning bidder for part of the commercial time slot may go to a light beer maker and another part of the commercial time slot may go to a microbrewery. The media device 102 would check the demographics of the user of the media device 102 when retrieving the commercial for the commercial time slot. If the media device user had previously identified themselves as an American lager drinker, then they would receive the commercial(s) for the light beer maker when they selected the free viewing option.

Additionally, or alternatively, in a system where the commercials are previously stored, information of the auction merchant-participant(s) that won the auction is sent to the media devices 102. The processor system 204 presents commercials stored in the memory 206, under management of the commercial processing logic 220, based on the received auction winner's information. For example, the commercials for companies A and B may be sent the media devices 102 well before any commercial time slots of a media content event have been defined and/or filled. When the media devices 102 receives information that company A won an auction for an available commercial time slot in the media content event, the processor system 204 retrieves the stored commercial for company A and outputs the retrieved commercial to the media presentation system 108 during the presented commercial break.

Additionally, or alternatively, when the commercials are presented during commercial breaks and or time slots of a media content event, selected user interface functions for forwarding through the commercials are deactivated. For example, fast forward, jump ahead, and other such functions are disabled. This prevents users from skipping or fast forwarding thru commercials, thus making commercial time slots more valuable. However, a pause action or a rewind action may be performed since such actions do not permit the user to avoid viewing the commercials.

It should be emphasized that the above-described embodiments of the media content pricing system 100 are merely possible examples of implementations of the invention. Many variations and modifications may be made to the above-described embodiments. All such modifications and variations are intended to be included herein within the scope of this disclosure and protected by the following claims.

The invention claimed is:

1. A method performed at a media device, the method comprising:
receiving a user selection identifying one of a plurality of commercial viewing options associated with a media content event;
determining if commercials are to be presented within at least one commercial break of the media content event based on the received user selection;
selecting commercials to be presented based on the received user selected commercial viewing option if commercials are determined to be presented during the at least one commercial break;
presenting the media content event; and
presenting selected commercials during designated commercial breaks during presentation of the media content event if commercials are determined to be presented during the at least one commercial break.

2. The method of claim 1, wherein receiving a user selection identifying one of the commercial viewing options comprises:
receiving a user selection of a no commercial viewing option from the plurality of commercial viewing options, wherein the no commercial viewing option is associated with a predefined price paid by the user to access the media content event with no presented commercials,
wherein the determining determines that no commercials are to be presented during the at least one commercial break, wherein no commercials are selected, and wherein no commercials are presented.

3. The method of claim 1, further comprising:
presenting a first commercial viewing option defined by a first price, and defined by a first number of commercial breaks; and
presenting a second viewing option defined by a second price, and defined by a second number of commercial breaks,
wherein the second price is greater than the first price, and
wherein a total duration of the second number of commercial breaks is greater than a total duration of the first number of commercial breaks.

4. The method of claim 3, wherein the first number of commercial breaks is defined by a first number of commercial time slots, wherein the second number of commercial breaks is defined by a second number of commercial time slots, and wherein the second number of commercial time slots is greater than the first number of commercial time slots.

5. The method of claim 1, wherein prior to receiving the user selection, the method further comprises:
receiving a plurality of commercials from a server device via a communication system;
storing the plurality of commercials in a memory; and
selecting the commercials to be presented from the plurality of stored commercials.

6. The method of claim 5, wherein selecting the presented commercials comprises:
receiving identification from the server device of the commercials to be presented; and
retrieving the identified commercials from the memory.

7. The method of claim 5, wherein selecting the presented commercials from the plurality of received commercials based on the user selection further comprises:
selecting the commercials to be presented from the memory based on demographic information associated with a user of the media device.

8. The method of claim 1, further comprising:
sending the user selection to a server device via a communication system, wherein the server device selects the commercials to be presented.

9. The method of claim 8, further comprising;
receiving the selected commercials to be presented from the server device.

10. A media device, comprising:
an interface configured to receive a user selection specifying one of a plurality of commercial viewing options associated with a media content event selected for presentation by the user; and
a processor system in signal communication with the interface, the processor system configured to:
present the media content event;
determine whether commercials are to be presented within at least one commercial break in the media content event based on the received user selection; and
if commercials are determined to be presented, present selected commercials during the at least one commercial break based on the received user selection.

11. The media device of claim 10, wherein at least one of the commercial viewing options comprises no commercials, and wherein the media content event is presented with no commercial breaks.

12. The media device of claim 11, wherein the commercial viewing options comprise a first number of commercial breaks for a first price and a second number of commercial breaks for a second price, wherein the second price is greater than the first price, and wherein a total duration of the second number of commercial breaks is greater than a total duration of the first number of commercial breaks.

13. The media device of claim 11, further comprising:
a memory configured to store a plurality of commercials received prior to the user selection,
wherein the processor system is further configured to retrieve selected ones of the stored plurality of commercials from the memory based on the received user selection.

14. The media device of claim 13, wherein the processor system further selects the commercials from the memory based on demographic information associated with a user of the media device.

15. The media device of claim 11, further comprising:
a communication system interface in communication with the processor system and configured to communicatively couple to a server device via a communication system,
wherein the processor system is further configured to send the user selection to the server device.

16. The media device of claim 15, wherein the processor system is further configured to receive a plurality of commercials presented during the at least one commercial break from the server device.

17. A method performed at a server device being in signal communication with a plurality of media devices, the method comprising:
receiving from a media device a user selection specifying one of a plurality of commercial viewing options associated with a media content event;
selecting at least one commercial based on the received user selection, wherein the at least one commercial is to be presented during at least one commercial break during presentation of the media content event; and
sending the selected at least one commercial to the media device via a communication system.

18. The method of claim 17, wherein retrieving comprises:
retrieving demographic information associated with a user associated with the media device; and
selecting the at least one commercial based on the retrieved demographic information.

19. The method of claim 17, further comprising:
defining at least one time slot of the at least one commercial break;
receiving bids from a plurality of merchant-participant entities for the at least one time slot associated with the media content event; and
receiving a specification of the selected at least one commercial from a winning one of the merchant-participant entities.

20. The method of claim 19, wherein prior to receiving the bids, the method further comprising:
communicating demographic information associated with a user associated with the media device to the plurality of merchant-participant entities.
